(19) United States
(12) Patent Application Publication
(10) Pub. No.: US 2016/0186043 A1
(43) Pub. Date: Jun. 30, 2016

(54) ENHANCED OIL RECOVERY USING CARBOXYLATE GROUP CONTAINING SURFACTANTS

(71) Applicant: SHELL OIL COMPANY, Houston, TX (US)

(72) Inventors: Kirk Herbert RANEY, Houston, TX (US); Jasper Roelf SMIT, Amsterdam (NL); Julian Richard BARNES, Amsterdam (NL)

(21) Appl. No.: 15/060,642

(22) Filed: Mar. 4, 2016

(51) Int. Cl. C09K 8/584; E21B 43/16

(52) U.S. Cl. CPC C09K 8/584; E21B 43/16

(57) ABSTRACT

The invention relates to a method of treating a hydrocarbon containing formation, comprising the following steps: a) providing a composition comprising a surfactant to at least a portion of the hydrocarbon containing formation, wherein the surfactant is a compound of the formula (I) R—O—[R′—O]ₓ—X wherein R is a hydrocarbyl group, R′—O is an alkylene oxide group, x is the number of alkylene oxide groups R′—O, and X is a group comprising a carboxylate moiety; b) allowing the surfactant from the composition to interact with the hydrocarbons in the hydrocarbon containing formation; c) recovering from the hydrocarbon containing formation an emulsion comprising hydrocarbons, water and the surfactant; and d) adding an acid to the emulsion thus recovered.

### FIELD OF THE INVENTION

The present invention relates to a method of treating a hydrocarbon containing formation using carboxylate group containing surfactants.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation. Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof.

Methods of chemical Enhanced Oil Recovery (cEOR) are applied in order to maximise the yield of hydrocarbons from a subterranean reservoir. In surfactant cEOR, the mobilisation of residual oil is achieved through surfactants which generate a sufficiently low crude oil/water interfacial tension (IFT) to give a capillary number large enough to overcome capillary forces and allow the oil to flow (Lake, Larry W., “Enhanced oil recovery”, PRENTICE HALL, Upper Saddle River, N.J., 1989, ISBN 0-13-281601-6).

For example, it is known to use carboxylates of alkoxylated or non-alkoxylated alcohols as surfactants in cEOR. In general, any surfactant to be used in cEOR should have a good cEOR performance, for example in terms of reducing the IFT. Further cEOR performance parameters other than said IFT, are optimal salinity and aqueous solubility at such optimal salinity. By “optimal salinity”, reference is made to the salinity of the brine present in a mixture comprising said brine (a salt-containing aqueous solution), the hydrocarbons (e.g. oil) and the surfactant(s), at which salinity said IFT is lowest. A good microemulsion phase behavior for the surfactant(s) is desired since this is indicative for such low IFT and a low viscosity of the oil/water microemulsion. In addition, it is desired that at or close to such optimal salinity, said aqueous solubility of the surfactant(s) is sufficient to good.

However, is not only important that a surfactant, like the above-mentioned carboxylate group containing surfactant, has a good cEOR performance. After injection of a composition containing such carboxylate group containing surfactant into a hydrocarbon containing formation, such surfactant will interact with the hydrocarbons in that formation thereby reducing the IFT between oil and water and forming an emulsion comprising oil, water and surfactant. However, after recovery of such emulsion from the hydrocarbon containing formation, in order to recover oil from the emulsion thus recovered, that emulsion has to be “broken” (demulsified) such that one separate water-containing layer and one separate oil-containing layer can be formed after which the oil-containing layer could be easily separated using for example a bulk separation tank in a produced fluid treatment plant.

It is known in the industry that to demulsify emulsions from produced fluids resulting from water flooding, chemical demulsifiers are quite effective. Different classes of demulsifiers are available and can be distinguished based on their chemical structure (Kelland, M. A.; Production Chemicals for the Oil and Gas Industry; CRC Press, Boca Raton, Fla., 2009, ISBN 1420092901). For example the following can be used: 1) alkoxylated alkylphenol-aldehyde resins which concerns a widely used class of demulsifiers in which many varieties are available; 2) polyalkoxylate block copolymers and their ester derivatives; 3) polyalkoxylates of polyols; 4) (polyalkoxylated) polyamines and their amide derivatives; 5) nitrogen-based cationic surfactants or polymers; 6) (polyalkoxylated) polyurethanes; 7) hyperbranched polymers; 8) alkoxylated vinyl polymers; 9) polysilicones; and 10) polyalkoxylate-polysiloxane block copolymers.

The demulsifier type and its concentration need to be matched to the type of emulsion to be broken with an emphasis on minimizing demulsifier dose rate to minimise the cost of these expensive chemicals. For produced emulsions resulting from a surfactant containing flood (with optionally a polymer) it is expected that breaking emulsions would be even more difficult as compared with the conventional water flooding case as the surfactant would tend to stabilize the different types of emulsions formed. The cost of demulsifier treatment might be a significant cost element of the total project involving cEOR, for example when using carboxylate, sulfate or sulfonate group containing surfactants.

It is an object of the present invention to provide a suitable, simple and cost-effective method for breaking an emulsion comprising hydrocarbons, water and a surfactant, which emulsion is recovered from a hydrocarbon containing formation after a composition comprising said surfactant is provided to said formation.

### SUMMARY OF THE INVENTION

Surprisingly it was found that the above-mentioned object can be achieved by using a carboxylate group containing compound as the surfactant and by adding an acid to an emulsion comprising hydrocarbons, water and the carboxylate group containing surfactant, as recovered from a hydrocarbon containing formation.

Accordingly, the present invention relates to a method of treating a hydrocarbon containing formation, comprising the following steps:

a) providing a composition comprising a surfactant to at least a portion of the hydrocarbon containing formation, wherein the surfactant is a compound of the formula (I)

R—O—[R′—O]ₓ—X Formula (I)

wherein R is a hydrocarbyl group, R′—O is an alkylene oxide group, x is the number of alkylene oxide groups R′—O, and X is a group comprising a carboxylate moiety;

b) allowing the surfactant from the composition to interact with the hydrocarbons in the hydrocarbon containing formation;

c) recovering from the hydrocarbon containing formation an emulsion comprising hydrocarbons, water and the surfactant; and

d) adding an acid to the emulsion thus recovered.

### BRIEF DESCRIPTION OF THE DRAWINGS

FIG. 1 illustrates the reactions of an internal olefin with sulfur trioxide (sulfonating agent) during a sulfonation process.

FIG. 2 illustrates the subsequent neutralization and hydrolysis process to form an internal olefin sulfonate.

FIG. 3 relates to an embodiment for application in cEOR.

FIG. 4 relates to another embodiment for application in cEOR.

### DETAILED DESCRIPTION OF THE INVENTION

In the context of the present invention, in a case where a composition comprises two or more components, these components are to be selected in an overall amount not to exceed 100%.

While the method of the present invention and the composition used in said method are described in terms of “comprising”, “containing” or “including” one or more various described steps and components, respectively, they can also “consist essentially of” or “consist of” said one or more various described steps and components, respectively.“.

Within the present specification, “substantially no” means that no detectible amount is present.

In the cEOR method of the present invention, a composition comprising a carboxylate group containing surfactant is provided to at least a portion of the hydrocarbon containing formation. Said carboxylate group containing surfactant is a compound of the formula (I)

R—O—[R′—O]ₓ—X Formula (I)

wherein R is a hydrocarbyl group, R′—O is an alkylene oxide group, x is the number of alkylene oxide groups R′—O, and X is a group comprising a carboxylate moiety.

In the present invention, the weight average carbon number for the hydrocarbyl group R in said formula (I) is suitably of from 5 to 30, more suitably 5 to 25, more suitably 8 to 20, most suitably 9 to 18.

The hydrocarbyl group R in said formula (I) may be aliphatic or aromatic, suitably aliphatic. When said hydrocarbyl group R is aliphatic, it may be an alkyl group, cycloalkyl group or alkenyl group, suitably an alkyl group. Said hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. Preferably, in the present invention, the hydrocarbyl group R in the above formula (I) originates from a non-alkoxylated alcohol R—OH which only contains 1 hydroxyl group (mono-alcohol). Further, said alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, number of branches for the aliphatic group R, and molecular weight.

Preferably, the hydrocarbyl group R in the above formula (I) is an alkyl group. Said alkyl group may be linear or branched, and has a weight average carbon number which is suitably of from 5 to 30, more suitably 5 to 25, more suitably 8 to 20, most suitably 9 to 18. In a case where said alkyl group is linear and contains 3 or more carbon atoms, the alkyl group is attached either via its terminal carbon atom or an internal carbon atom to the oxygen atom, preferably via its terminal carbon atom.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306, U.S. Pat. No. 5,648,584 and U.S. Pat. No. 5,648,585. Preparations of branched long chain aliphatic alcohols are described in U.S. Pat. No. 5,849,960, U.S. Pat. No. 6,150,222, U.S. Pat. No. 6,222,077.

Suitable examples of commercially available non-alkoxylated alcohols (of said formula R—OH) are the NEODOL (NEODOL, as used throughout this text, is a trademark) alcohols, sold by Shell Chemical Company. For example, said NEODOL alcohols include NEODOL 23 which is a mixture of mainly C₁₂ and C₁₃ alcohols of which the weight average carbon number is 12.6; NEODOL 25 which is a mixture of mainly C₁₂, C₁₃, C₁₄ and C₁₅ alcohols of which the weight average carbon number is 13.5; NEODOL 45 which is a mixture of mainly C₁₄ and C₁₅ alcohols of which the weight average carbon number is 14.5; and NEODOL 67 which is a mixture of mainly C16 and C17 alcohols of which the weight average carbon number is 16.7.

The alkylene oxide groups R′—O in the above formula (I) may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. Preferably, said alkylene oxide groups consist of ethylene oxide groups or propylene oxide groups or a mixture of ethylene oxide and propylene oxide groups. In case of a mixture of different alkylene oxide groups, the mixture may be random or blockwise.

In the above formula (I), x represents the number of alkylene oxide groups R′—O. In the present invention, either x is 0 (non-alkoxylated alcohol) or greater than 0 (alkoxylated alcohol). In a case where x is greater than 0, the average value for x may be at least 0.5, suitably of from 1 to 50, more suitably of from 1 to 40, more suitably of from 2 to 35, more suitably of from 2 to 30, more suitably of from 2 to 25, more suitably of from 3 to 20, most suitably of from 3 to 18.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which is commonly used commercially. Alternatively, a double metal cyanide catalyst may be used, as described in U.S. Pat. No. 6,977,236. Still further, a lanthanum-based or a rare earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, which catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with 7 moles of alkylene oxide per mole of primary alcohol serves to effect the alkoxylation of each alcohol molecule with 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Since a carboxylate moiety is anionic, the resulting compound of the above formula (I) is an anionic surfactant. In the present invention, the cation for an anionic surfactant, like said surfactant of the above formula (I), may be any cation, such as an ammonium, alkali metal or alkaline earth metal cation, preferably an ammonium or alkali metal cation. Surfactants of the formula (I) wherein X is a group comprising an anionic moiety, like a carboxylate moiety, may be prepared from the above-described alcohols of the formula R—O—[R′—O]ₓ—H, as is further described hereinbelow.

In the present invention, it is preferred that the carboxylate group containing surfactant of the above formula (I) is of the formula (II)

R—O—[R′—O]ₓ-L-C(═O)O⁻ Formula (II)

wherein R, R′ and x have the above-described meanings and L is an alkyl group, suitably a C₁-C₄ alkyl group, which may be unsubstituted or substituted, and wherein the —C(═O)O⁻ moiety is the carboxylate moiety.

The alcohol R—O—[R′—O]ₓ—H may be carboxylated by any one of a number of well-known methods. It may be reacted, preferably after deprotonation with a base, with a halogenated carboxylic acid, for example chloroacetic acid, or a halogenated carboxylate, for example sodium chloroacetate. Alternatively, the alcoholic end group may be oxidized to yield a carboxylic acid, in which case the number x (number of alkylene oxide groups) is reduced by 1. Any carboxylic acid product may then be neutralized with an alkali metal base to form a carboxylate surfactant.

In a specific example, an alcohol may be reacted with potassium t-butoxide and initially heated at for example 60° C. under reduced pressure for example 10 hours. It would be allowed to cool and then sodium chloroacetate would be added to the mixture. The reaction temperature would be increased to for example 90° C. under reduced pressure and heating at said temperature would take place for example 20-21 hours. It would be cooled to room temperature and water and hydrochloric acid would be added. This would be heated at for example 90° C. for example 2 hours. The organic layer may be extracted by adding ethyl acetate and washing it with water.

In step d) of the present method, an acid is added to the emulsion comprising hydrocarbons, water and the carboxylate group containing surfactant as recovered from the hydrocarbon containing formation in step c). The effect of adding an acid is that the emulsion is “broken” (or demulsified) so that the oil can be more easily separated from the water. It is preferred that two separate layers are formed upon demulsifcation by adding the acid, namely one water-containing layer and one hydrocarbons-containing layer, which 2 layers could be easily separated using for example a bulk separation tank in a produced fluid treatment plant.

It is preferred that the remaining amount of any water in said hydrocarbons layer, like an oil layer, is relatively low, at least below 10 wt. % and preferably below 0.5%. In the produced fluid treatment plant the typical target output oil quality from the bulk separation tank is 10 wt. % water in oil and the typical target output oil quality following a second treatment stage, oil dehydration, is <0.5 wt. % water in oil. Further, it is preferred that the remaining amount of any oil in the water layer after the bulk separation stage is relatively low, for example <0.2 wt. % and preferably <0.01 wt. % oil in water. The water is further processed in the produced fluid treatment plant to remove oil further and give a target oil content in water of <30 ppmw. This is required so that the water can be re-injected into the reservoir.

By adding an acid to the above-mentioned emulsion, the pH of said emulsion is reduced by which the carboxylate moiety in the above-mentioned surfactant may become protonated to a certain extent. Preferably, in the present invention, the amount and pKₐ of the acid that is added are such that the pH of the emulsion is decreased to a value below 7, or to a value in the range of from 1 to 7, more preferably 2 to 7, more preferably 3 to 7, more preferably 3 to 6, more preferably 3 to 5.

The nature of the acid is not essential, as long as it is able to decrease the pH to a certain extent, for example to a value in any one of the above-mentioned ranges.

Acids to be used in the present invention may be organic or inorganic acids, suitable examples being sulfuric acid, hydrochloric acid and acetic acid. Other suitable examples are citric acid and ascorbic acid. Generally, an acid may be used which has a pKₐ below 7, or a pKₐ in the range of from 1 to 7, more preferably 2 to 7, more preferably 3 to 7, more preferably 3 to 6, more preferably 3 to 5. In the present invention, any acid having a pKₐ in the above-mentioned ranges may be used. The acid may be organic or inorganic. For example, suitable acids having a pKₐ in the above-mentioned ranges are listed at pages D-161 to D-165 in the following publication: “CRC Handbook of Chemistry and Physics”, 1989-1990, 70^{th} edition, CRC Press, Inc.

The acid may be added in the form of an aqueous solution containing the acid, and further in concentrated form or in diluted form.

Further, it is preferred that during and after addition of the acid, the emulsion is well mixed, for example by stirring. For example, the acid may be mixed with the produced fluid (emulsion) in a bulk separation tank. Such tank may have exit pipes at least two vertical levels in the bulk separation tank, to draw off the separated oil and water layers. Optionally, there may be a third exit pipe, at an intermediate level, in case a “rag layer” is present between the oil and water layers that needs to be drawn off.

In addition to the above-mentioned carboxylate group containing surfactant of the above formula (I), the composition to be provided to the hydrocarbon containing formation may contain one or more other surfactants. These one or more other surfactants may be selected from the group consisting of (a) an internal olefin sulfonate; (b) an alpha olefin sulfonate; (c) an alkyl aromatic sulfonate; and (d) a compound of the formula (III)

R—O—[R′—O]ₓ—X Formula (III)

wherein R is a hydrocarbyl group, R′—O is an alkylene oxide group, x is the number of alkylene oxide groups R′—O, and X is selected from the group consisting of: (i) a hydrogen atom; (ii) a group comprising a sulfate moiety; and (iii) a group comprising a sulfonate moiety.

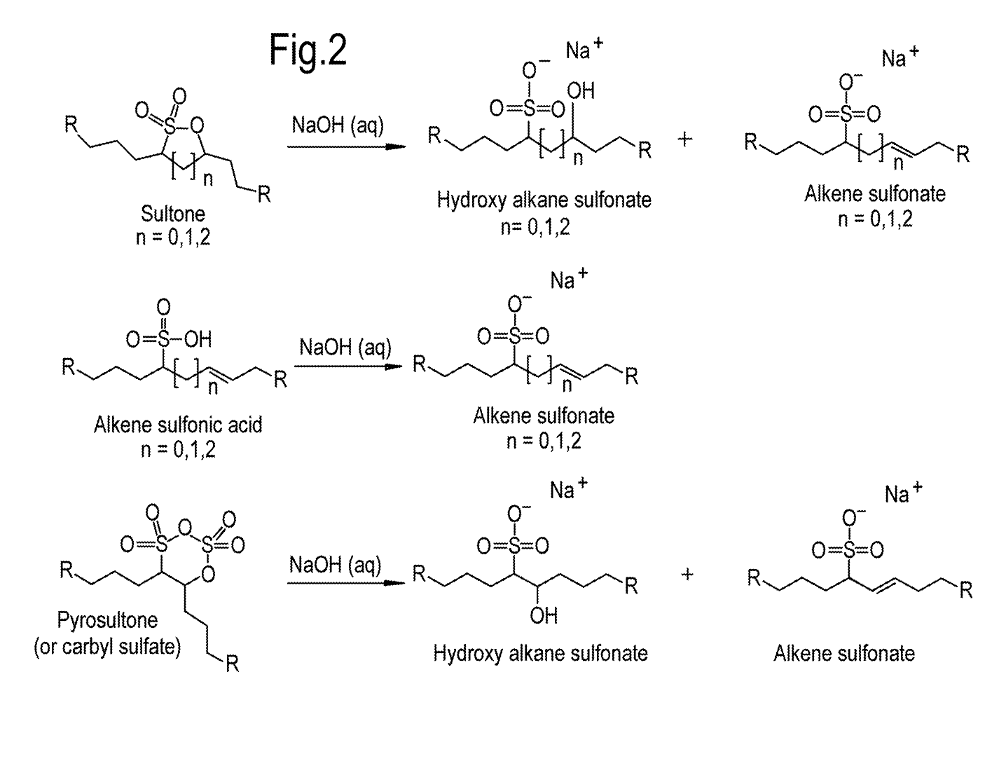

As mentioned under (a) in the above-mentioned list of other surfactants, an additional surfactant from the composition to be provided to the hydrocarbon containing formation may be an internal olefin sulfonate (IOS). In such case, the composition comprises internal olefin sulfonate molecules. An internal olefin sulfonate molecule is an alkene or hydroxyalkane which contains one or more sulfonate groups. Examples of such internal olefin sulfonate molecules are shown in FIG. 2, which shows hydroxy alkane sulfonates (HAS) and alkene sulfonates (OS).

Thus, the composition used in the present cEOR method may comprise an internal olefin sulfonate. Said internal olefin sulfonate (IOS) is prepared from an internal olefin by sulfonation. Within the present specification, an internal olefin and an IOS comprise a mixture of internal olefin molecules and a mixture of IOS molecules, respectively. That is to say, within the present specification, “internal olefin” as such refers to a mixture of internal olefin molecules whereas “internal olefin molecule” refers to one of the components from such internal olefin. Analogously, within the present specification, “IOS” or “internal olefin sulfonate” as such refers to a mixture of IOS molecules whereas “IOS molecule” or “internal olefin sulfonate molecule” refers to one of the components from such IOS. Said molecules differ from each other for example in terms of carbon number and/or branching degree.

Branched IOS molecules are IOS molecules derived from internal olefin molecules which comprise one or more branches. Linear IOS molecules are IOS molecules derived from internal olefin molecules which are linear, that is to say which comprise no branches (unbranched internal olefin molecules). An internal olefin may be a mixture of linear internal olefin molecules and branched internal olefin molecules. Analogously, an IOS may be a mixture of linear IOS molecules and branched IOS molecules.

An internal olefin or IOS may be characterised by its carbon number, linearity, number of branches and/or molecular weight

In case reference is made to an average carbon number, this means that the internal olefin or IOS in question is a mixture of molecules which differ from each other in terms of carbon number. Within the present specification, said average carbon number is determined by multiplying the number of carbon atoms of each molecule by the weight fraction of that molecule and then adding the products, resulting in a weight average carbon number. The average carbon number may be determined by gas chromatography (GC) analysis of the internal olefin.

Within the present specification, linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin.

Within the present specification, the average number of branches is determined by dividing the total number of branches by the total number of molecules, resulting in a “branching index” (BI). Said branching index may be determined by ¹H-NMR analysis.

When the branching index is determined by ¹H-NMR analysis, said total number of branches equals: [total number of branches on olefinic carbon atoms (olefinic branches)]+[total number of branches on aliphatic carbon atoms (aliphatic branches)]. Said total number of aliphatic branches equals the number of methine groups, which latter groups are of formula R₃CH wherein R is an alkyl group.

Further, said total number of olefinic branches equals: [number of trisubstituted double bonds]+[number of vinylidene double bonds]+2*[number of tetrasubstituted double bonds]. Formulas for said trisubstituted double bond, vinylidene double bond and tetrasubstituted double bond are shown below. In all of the below formulas, R is an alkyl group.

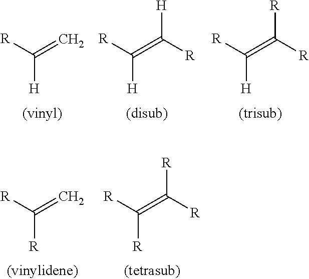

Within the present specification, said average molecular weight is determined by multiplying the molecular weight of each surfactant molecule by the weight fraction of that molecule and then adding the products, resulting in a weight average molecular weight.

The foregoing passages regarding (average) carbon number, linearity, branching index and molecular weight apply analogously to the first surfactant (the carboxylate group containing surfactant) and any other additional non-IOS type of surfactant as described above.

Thus, the composition used in the present cEOR method may comprise an internal olefin sulfonate (IOS). Preferably at least 60 wt. %, more preferably at least 70 wt. %, more preferably at least 80 wt. %, most preferably at least 90 wt. % of said IOS is linear. For example, 60 to 100 wt. %, more suitably 70 to 99 wt. %, most suitably 80 to 99 wt. % of said IOS may be linear. Branches in said IOS may include methyl, ethyl and/or higher molecular weight branches including propyl branches.

Further, preferably, said IOS is not substituted by groups other than sulfonate groups and optionally hydroxy groups. Further, preferably, said IOS has an average carbon number in the range of from 5 to 30, more preferably 8 to 27, more preferably 10 to 24, more preferably 12 to 22, more preferably 13 to 20, more preferably 14 to 19, most preferably 15 to 18.

Still further, preferably, said IOS may have a carbon number distribution within broad ranges. For example, in the present invention, said IOS may be selected from the group consisting of C₁₅₋₁₈ IOS, C₁₉₋₂₃ IOS, C₂₀₋₂₄ IOS, C₂₄₋₂₈ IOS and mixtures thereof, wherein “IOS” stands for “internal olefin sulfonate”. IOS suitable for use in the present invention include those from the ENORDET™ O series of surfactants commercially available from Shell Chemicals Company.

“C₁₅₋₁₈ internal olefin sulfonate” (C₁₅₋₁₈ IOS) as used herein means a mixture of internal olefin sulfonate molecules wherein the mixture has an average carbon number of from 16 to 17 and at least 50% by weight, preferably at least 65% by weight, more preferably at least 75% by weight, most preferably at least 90% by weight, of the internal olefin sulfonate molecules in the mixture contain from 15 to 18 carbon atoms.

“C₁₉₋₂₃ internal olefin sulfonate” (C₁₉₋₂₃ IOS) as used herein means a mixture of internal olefin sulfonate molecules wherein the mixture has an average carbon number of from 21 to 23 and at least 50% by weight, preferably at least 60% by weight, of the internal olefin sulfonate molecules in the mixture contain from 19 to 23 carbon atoms.

“C₂₀₋₂₄ internal olefin sulfonate” (C₂₀₋₂₄ IOS) as used herein means a mixture of internal olefin sulfonate molecules wherein the mixture has an average carbon number of from 20 to 23 and at least 50% by weight, preferably at least 65% by weight, more preferably at least 75% by weight, most preferably at least 90% by weight, of the internal olefin sulfonate molecules in the mixture contain from 20 to 24 carbon atoms.

“C₂₄₋₂₈ internal olefin sulfonate” (C₂₄₋₂₈ IOS) as used herein means a mixture of internal olefin sulfonate molecules wherein the mixture has an average carbon number of from 24.5 to 27 and at least 40% by weight, preferably at least 45% by weight, of the internal olefin sulfonate molecules in the mixture contain from 24 to 28 carbon atoms.

Further, for the internal olefin sulfonates which are substituted by sulfonate groups, the cation may be any cation, such as an ammonium, alkali metal or alkaline earth metal cation, preferably an ammonium or alkali metal cation.

An IOS molecule is made from an internal olefin molecule whose double bond is located anywhere along the carbon chain except at a terminal carbon atom. Internal olefin molecules may be made by double bond isomerization of alpha olefin molecules whose double bond is located at a terminal position. Generally, such isomerization results in a mixture of internal olefin molecules whose double bonds are located at different internal positions. The distribution of the double bond positions is mostly thermodynamically determined. Further, that mixture may also comprise a minor amount of non-isomerized alpha olefins. Still further, because the starting alpha olefin may comprise a minor amount of paraffins (non-olefinic alkanes), the mixture resulting from alpha olefin isomeration may likewise comprise that minor amount of unreacted paraffins.

In the present invention, the amount of alpha olefins in the internal olefin may be up to 5%, for example 1 to 4 wt. % based on total composition. Further, in the present invention, the amount of paraffins in the internal olefin may be up to 2 wt. %, for example up to 1 wt. % based on total composition.

Suitable processes for making an internal olefin include those described in U.S. Pat. No. 5,510,306, U.S. Pat. No. 5,633,422, U.S. Pat. No. 5,648,584, U.S. Pat. No. 5,648,585, U.S. Pat. No. 5,849,960, EP0830315B1 and “Anionic Surfactants: Organic Chemistry”, Surfactant Science Series, volume 56, Chapter 7, Marcel Dekker, Inc., New York, 1996, ed. H. W. Stacke.

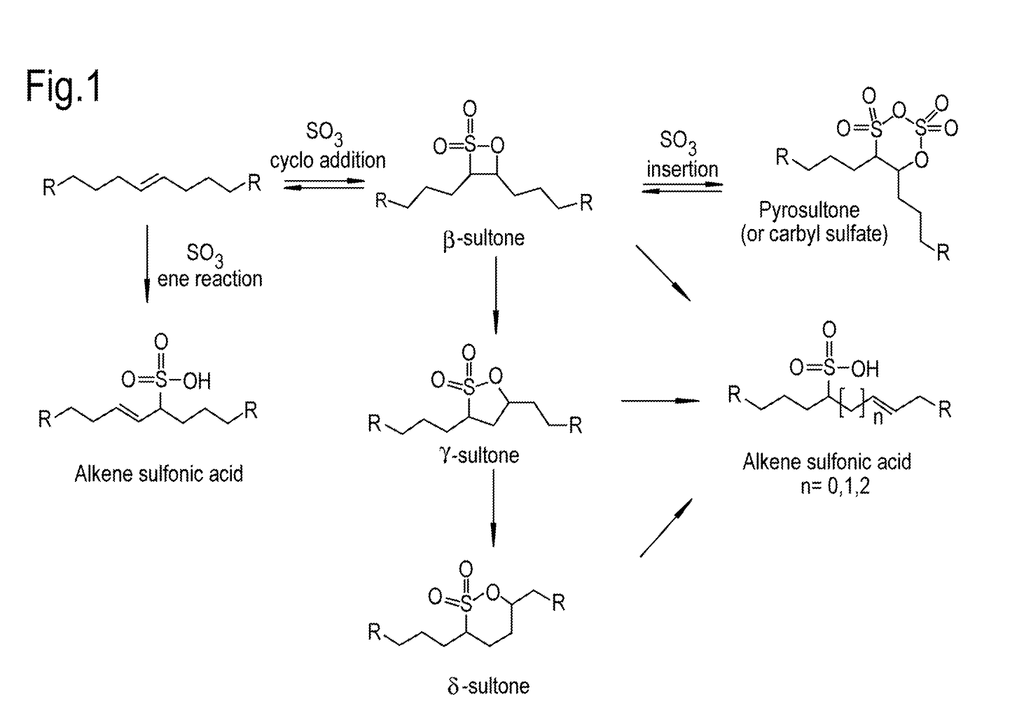

In the sulfonation step, the internal olefin is contacted with a sulfonating agent. Referring to FIG. 1, reaction of the sulfonating agent with an internal olefin leads to the formation of cyclic intermediates known as beta-sultones, which can undergo isomerization to unsaturated sulfonic acids and the more stable gamma- and delta-sultones.

In a next step, sulfonated internal olefin from the sulfonation step is contacted with a base containing solution. Referring to FIG. 2, in this step, beta-sultones are converted into beta-hydroxyalkane sulfonates, whereas gamma- and delta-sultones are converted into gamma-hydroxyalkane sulfonates and delta-hydroxyalkane sulfonates, respectively. Part of said hydroxyalkane sulfonates may be dehydrated into alkene sulfonates.

Thus, referring to FIGS. 1 and 2, an IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Hydroxyalkane sulfonate molecules and alkene sulfonate molecules are shown in FIG. 2. Di-sulfonate molecules (not shown in FIG. 2) originate from a further sulfonation of for example an alkene sulfonic acid as shown in FIG. 1.

The IOS may comprise at least 30% hydroxyalkane sulfonate molecules, up to 70% alkene sulfonate molecules and up to 15% di-sulfonate molecules. Suitably, the IOS comprises from 40% to 95% hydroxyalkane sulfonate molecules, from 5% to 50% alkene sulfonate molecules and from 0% to 10% di-sulfonate molecules. Beneficially, the IOS comprises from 50% to 90% hydroxyalkane sulfonate molecules, from 10% to 40% alkene sulfonate molecules and from less than 1% to 5% di-sulfonate molecules. More beneficially, the IOS comprises from 70% to 90% hydroxyalkane sulfonate molecules, from 10% to 30% alkene sulfonate molecules and less than 1% di-sulfonate molecules. The composition of the IOS may be measured using a liquid chromatography/mass spectrometry (LC-MS) technique.

U.S. Pat. No. 4,183,867, U.S. Pat. No. 4,248,793 and EP0351928A1 disclose processes which can be used to make internal olefin sulfonates. Further, the internal olefin sulfonates may be synthesized in a way as described by Van Os et al. in “Anionic Surfactants: Organic Chemistry”, Surfactant Science Series 56, ed. Stacke H. W., 1996, Chapter 7: Olefin sulfonates, pages 367-371.

As mentioned under (b) in the above-mentioned list of other surfactants, an additional surfactant from the composition to be provided to the hydrocarbon containing formation may be an alpha olefin sulfonate (AOS). An AOS differs from an internal olefin sulfonate (IOS) in that an AOS is made from an alpha olefin, whose double bond is located at a terminal position. Unless indicated otherwise hereinbelow, the above disclosures regarding IOS equally apply to AOS.

Said AOS preferably has an average carbon number in the range of from 5 to 30, more preferably 8 to 25, more preferably 8 to 22, more preferably 9 to 20, more preferably 10 to 18, most preferably 12 to 16.

As mentioned under (c) in the above-mentioned list of other surfactants, an additional surfactant from the composition to be provided to the hydrocarbon containing formation may be an alkyl aromatic sulfonate. Within the present specification, by “alkyl aromatic sulfonate” reference is made to an aromatic compound which is substituted by both an alkyl group and a sulfonate moiety. Such alkyl aromatic sulfonate may be shown by the formula (IV)

R—Ar—S(═O)₂O⁻ Formula (IV)

wherein R is an alkyl group and Ar is an aromatic group.

The alkyl group R in the above formula (IV) may be linear or branched, preferably linear. Further, it may have an average carbon number within wide ranges, for example of from 1 to 40, suitably 1 to 30, more suitably 1 to 20, more suitably 5 to 18, more suitably 8 to 16, more suitably 10 to 14, most suitably 10 to 13 carbon atoms. In a case where said alkyl group is linear and contains 3 or more carbon atoms, the alkyl group is attached either via its terminal carbon atom or an internal carbon atom to the benzene ring, preferably via its internal carbon atom.

The aromatic group Ar in the above formula (IV) may be a phenyl group or a group comprising 2 or more phenyl groups which may be fused, such as naphthalene. Preferably, the aromatic group Ar is a phenyl group. Said phenyl group is substituted by the above-described alkyl group R and by a sulfonate moiety. Preferably, the alkyl group R is attached to the para-position of the benzene ring relative to the sulfonate moiety. In addition to said 2 substituents, the phenyl group may be substituted by 1 or more, preferably 1, alkyl groups as described hereinbefore in relation to the alkyl group R, with the proviso that such other alkyl group preferably has a lower average carbon number, suitably of from 1 to 10, more suitably 1 to 8, more suitably 1 to 6, more suitably 1 to 4, most suitably 1 to 3 carbon atoms, for example a methyl group.

As mentioned under (d) in the above-mentioned list of other surfactants, an additional surfactant from the composition to be provided to the hydrocarbon containing formation may be a compound of the formula (III)

R—O—[R′—O]ₓ—X Formula (III)

wherein R is a hydrocarbyl group, R′—O is an alkylene oxide group, x is the number of alkylene oxide groups R′—O, and X is selected from the group consisting of: (i) a hydrogen atom; (ii) a group comprising a sulfate moiety; (iii) a group comprising a sulfonate moiety.

Unless indicated otherwise, the foregoing passages regarding the carboxylate group containing surfactant of the above formula (I) apply analogously to the optional, additional surfactant of the above formula (III).

In a case where X is a hydrogen atom, the compound of the above formula (III) is a nonionic surfactant. In the latter case, it is preferred that x (number of alkylene oxide groups) is not 0 but greater than 0, as described above.

Further, said sulfate and sulfonate moieties are anionic moieties, just like the above-mentioned carboxylate moiety, so that the resulting compound of the above formula (III) is likewise an anionic surfactant.

In a case where X in the above formula (III) is a group comprising a sulfate moiety, the optional, additional surfactant is of the formula (V)

R—O—[R′—O]ₓ—SO₃⁻ Formula (V)

wherein R, R′ and x have the above-described meanings, and wherein the —O—SO₃⁻ moiety is the sulfate moiety.

The alcohol R—O—[R′—O]ₓ—H may be sulfated by any one of a number of well-known methods, for example by using one of a number of sulfating agents including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature preferably not above 80° C. The sulfation may be carried out at temperature as low as −20° C. For example, the sulfation may be carried out at a temperature from 20 to 70° C., preferably from 20 to 60° C., and more preferably from 20 to 50° C.

Said alcohol may be reacted with a gas mixture which in addition to at least one inert gas contains from 1 to 8 vol. %, relative to the gas mixture, of gaseous sulfur trioxide, preferably from 1.5 to 5 vol. %. Although other inert gases are also suitable, air or nitrogen are preferred.

The reaction of said alcohol with the sulfur trioxide containing inert gas may be carried out in falling film reactors. Such reactors utilize a liquid film trickling in a thin layer on a cooled wall which is brought into contact in a continuous current with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from 0° C. to 65° C. and a pressure in the range from 100 to 200 kPa abs.

In a case where X in the above formula (III) is a group comprising a sulfonate moiety, the optional, additional surfactant is of the formula (VI)

R—O—[R′—O]ₓ-L-S(═O)₂O⁻ Formula (VI)

wherein R, R′ and x have the above-described meanings and L is an alkyl group, suitably a C₁-C₄ alkyl group, which may be unsubstituted or substituted, and wherein the —S(═O)₂O⁻ moiety is the sulfonate moiety.

The alcohol R—O—[R′—O]ₓ—H may be sulfonated by any one of a number of well-known methods. It may be reacted, preferably after deprotonation with a base, with a halogenated sulfonic acid, for example chloroethyl sulfonic acid, or a halogenated sulfonate, for example sodium chloroethyl sulfonate. Any resulting sulfonic acid product may then be neutralized with an alkali metal base to form a sulfonate surfactant.

Particularly suitable sulfonate surfactants are glycerol sulfonates. Glycerol sulfonates may be prepared by reacting the alcohol R—O—[R′—O]ₓ—H with epichlorohydrin, preferably in the presence of a catalyst such as tin tetrachloride, for example at from 110 to 120° C. and for from 3 to 5 hours at a pressure of 14.7 to 15.7 psia (100 to 110 kPa) in toluene. Next, the reaction product is reacted with a base such as sodium hydroxide or potassium hydroxide, for example at from 85 to 95° C. for from 2 to 4 hours at a pressure of 14.7 to 15.7 psia (100 to 110 kPa). The reaction mixture is cooled and separated in two layers. The organic layer is separated and the product isolated. It may then be reacted with sodium bisulfite and sodium sulfite, for example at from 140 to 160° C. for from 3 to 5 hours at a pressure of 60 to 80 psia (400 to 550 kPa). The reaction is cooled and the product glycerol sulfonate is recovered. Such glycerol sulfonate has the formula R—O—[R′—O]ₓ—CH₂—CH(OH)—CH₂—S(═O)₂O⁻.

In the present invention, a cosolvent (or solubilizer) may be added to (further) increase the solubility of the surfactants in the composition used in the present cEOR method and/or in the below-mentioned injectable fluid comprising said composition. Suitable examples of cosolvents are polar cosolvents, including lower alcohols (for example sec-butanol and isopropyl alcohol) and polyethylene glycol. Any amount of cosolvent needed to dissolve all of the surfactants at a certain salt concentration (salinity) may be easily determined by a skilled person through routine tests.

Still further, the composition used in the present cEOR method may comprise a base (herein also referred to as “alkali”), preferably an aqueous soluble base, including alkali metal containing bases such as for example sodium carbonate and sodium hydroxide. Treatment of a produced fluid (emulsion) arising from a carboxylate surfactant flood would practically be for a non-alkali, carboxylate surfactant flood. As the presence of alkali would mean that large (impracticable) amounts of acid are required to first neutralize the alkali, before the carboxylate group containing surfactant can be protonated.

Thus, the present invention relates to a method of treating a hydrocarbon containing formation, comprising the following steps:

a) providing a composition comprising the above-described carboxylate group containing surfactant to at least a portion of the hydrocarbon containing formation;

b) allowing the surfactant from the composition to interact with the hydrocarbons in the hydrocarbon containing formation;

c) recovering from the hydrocarbon containing formation an emulsion comprising hydrocarbons, water and the surfactant; and

d) adding an acid to the emulsion thus recovered.

By “hydrocarbon containing formation” reference is made to a sub-surface hydrocarbon containing formation.

In addition to adding an acid to the emulsion thus recovered, one or more of the (non-acidic) chemical demulsifiers mentioned above under “Background of the invention” may be added in step d) of the present method. By adding the acid, the usual dosage of such chemical demulsifiers can be drastically reduced, advantageously resulting in significant cost savings and at the same time resulting in an effective emulsion separation.

In the method of the present invention, more in particular in step b), the temperature may be 25° C. or higher. By said temperature reference is made to the temperature in the hydrocarbon containing formation. Preferably, said temperature is of from 40 to 200° C., more preferably of from 60 to 150° C. In practice, said temperature may vary strongly between different hydrocarbon containing formations. In the present invention, said temperature may be at least 25° C., suitably at least 40° C., more suitably at least 60° C., most suitably at least 90° C. Further, said temperature may be at most 200° C., suitably at most 180° C., more suitably at most 160° C., most suitably at most 150° C.

In the demulsification (above-surface) step d) of the present method, the temperature can be typically between 15 and 90° C., depending on the region and the temperature of the produced fluid exiting the production well of the reservoir.

In the present method of treating a hydrocarbon containing formation, in particular a crude oil-bearing formation, the surfactant(s) are applied in cEOR (chemical Enhanced Oil Recovery) at the location of the hydrocarbon containing formation, more in particular by providing the surfactant(s) containing composition to at least a portion of the hydrocarbon containing formation and then allowing the surfactant(s) from said composition to interact with the hydrocarbons in the hydrocarbon containing formation.

Normally, surfactants for enhanced hydrocarbon recovery are transported to a hydrocarbon recovery location and stored at that location in the form of an aqueous solution containing for example 30 to 35 wt. % of the surfactant(s). At the hydrocarbon recovery location, such solution would then be further diluted to a 0.05-2 wt. % solution, before it is injected into a hydrocarbon containing formation. By such dilution, an aqueous fluid is formed which fluid can be injected into the hydrocarbon containing formation, that is to say an injectable fluid. Preferably, in the present invention, the water or brine used in such further dilution, originates from the hydrocarbon containing formation (from which hydrocarbons are to be recovered) which advantageously may have a salinity within a wide range, as described above. One of the advantages is that such water or brine no longer has to be pre-treated such as to remove salts, thereby resulting in significant savings in time and costs. As described above, the water or brine originating from the hydrocarbon containing formation that may be used to dilute the surfactant(s) containing composition to be provided to said same hydrocarbon containing formation, may have a salinity of from 0.5 to 30 wt. % or 0.5 to 20 wt. % or 0.5 to 10 wt. % or 1 to 6 wt. %.

The total amount of the surfactant(s) in said injectable fluid may be of from 0.05 to 2 wt. %, preferably 0.1 to 1.5 wt. %, more preferably 0.1 to 1.0 wt. %, most preferably 0.2 to 0.5 wt. %.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilisation of hydrocarbons through the hydrocarbon containing formation.

Fluids (for example gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult.

Quantification of energy required for interactions (for example mixing) between fluids within a formation at an interface may be difficult to measure. Quantification of energy levels at an interface between fluids may be determined by generally known techniques (for example spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (for example greater than 10 dynes/cm) may indicate the inability of one fluid to mix with a second fluid to form a fluid emulsion. As used herein, an “emulsion” refers to a dispersion of one immiscible fluid into a second fluid by addition of a compound that reduces the interfacial tension between the fluids to achieve stability. The inability of the fluids to mix may be due to high surface interaction energy between the two fluids. Low interfacial tension values (for example less than 1 dyne/cm) may indicate less surface interaction between the two immiscible fluids. Less surface interaction energy between two immiscible fluids may result in the mixing of the two fluids to form an emulsion. Fluids with low interfacial tension values may be mobilised to a well bore due to reduced capillary forces and subsequently produced from a hydrocarbon containing formation. Thus, in surfactant cEOR, the mobilisation of residual oil is achieved through surfactants which generate a sufficiently low crude oil/water interfacial tension (IFT) to give a capillary number large enough to overcome capillary forces and allow the oil to flow.

Mobilisation of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on a number of factors, including the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (for example brine, steam), gases, polymers or any combinations thereof to the hydrocarbon containing formation to increase mobilisation of hydrocarbons.

In the present invention, the hydrocarbon containing formation is thus treated with the diluted or not-diluted surfactant(s) containing solution, as described above. Interaction of said solution with the hydrocarbons may reduce the interfacial tension of the hydrocarbons with one or more fluids in the hydrocarbon containing formation. The interfacial tension between the hydrocarbons and an overburden/underburden of a hydrocarbon containing formation may be reduced. Reduction of the interfacial tension may allow at least a portion of the hydrocarbons to mobilise through the hydrocarbon containing formation.

The ability of the surfactant(s) containing solution to reduce the interfacial tension of a mixture of hydrocarbons and fluids may be evaluated using known techniques. The interfacial tension value for a mixture of hydrocarbons and water may be determined using a spinning drop tensiometer. An amount of the surfactant(s) containing solution may be added to the hydrocarbon/water mixture and the interfacial tension value for the resulting fluid may be determined.

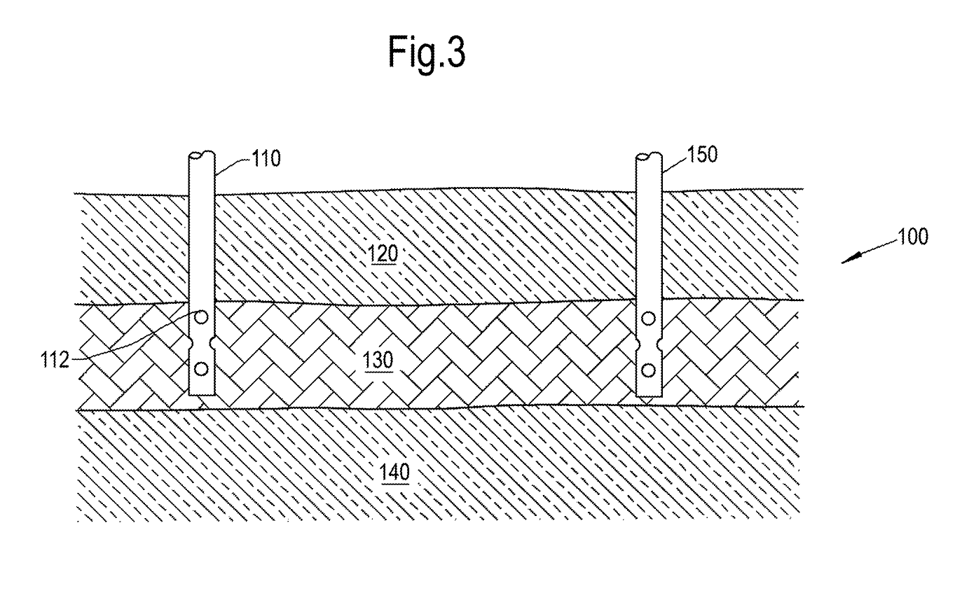

The surfactant(s) containing solution, diluted or not diluted, may be provided (for example injected in the form of a diluted aqueous fluid) into hydrocarbon containing formation 100 through injection well 110 as depicted in FIG. 3. Hydrocarbon containing formation 100 may include overburden 120, hydrocarbon layer 130 (the actual hydrocarbon containing formation), and underburden 140. Injection well 110 may include openings 112 (in a steel casing) that allow fluids to flow through hydrocarbon containing formation 100 at various depth levels. Low salinity water may be present in hydrocarbon containing formation 100.

The surfactant(s) from the surfactant(s) containing solution may interact with at least a portion of the hydrocarbons in hydrocarbon layer 130. This interaction may reduce at least a portion of the interfacial tension between one or more fluids (for example water, hydrocarbons) in the formation and the underburden 140, one or more fluids in the formation and the overburden 120 or combinations thereof.

The surfactant(s) from the surfactant(s) containing solution may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. The interfacial tension value between the hydrocarbons and one or more other fluids may be improved by the surfactant(s) containing solution to a value of less than 0.1 dyne/cm or less than 0.05 dyne/cm or less than 0.001 dyne/cm.

At least a portion of the surfactant(s) containing solution/hydrocarbon/fluids mixture may be mobilised to production well 150. Products obtained from the production well 150 may include components of the surfactant(s) containing solution, methane, carbon dioxide, hydrogen sulfide, water, hydrocarbons, ammonia, asphaltenes or combinations thereof. Hydrocarbon production from hydrocarbon containing formation 100 may be increased by greater than 50% after the surfactant(s) containing solution has been added to a hydrocarbon containing formation.

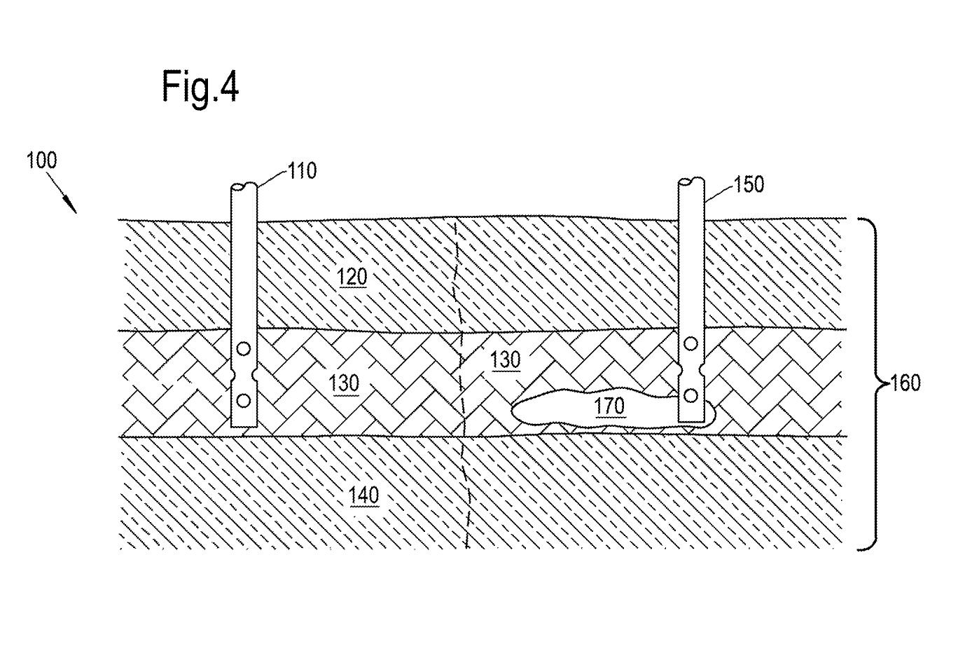

The surfactant(s) containing solution, diluted or not diluted, may also be injected into hydrocarbon containing formation 100 through injection well 110 as depicted in FIG. 4. Interaction of the surfactant(s) from the surfactant(s) containing solution with hydrocarbons in the formation may reduce at least a portion of the interfacial tension between the hydrocarbons and underburden 140. Reduction of at least a portion of the interfacial tension may mobilise at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

It may be beneficial under certain circumstances that an aqueous fluid, wherein the surfactant(s) containing solution is diluted, contains inorganic salt, such as sodium chloride, sodium hydroxide, potassium chloride, ammonium chloride, sodium sulfate or sodium carbonate. Such inorganic salt may be added separately from the surfactant(s) containing solution or it may be included in the surfactant(s) containing solution before it is diluted in water. The addition of the inorganic salt may help the fluid disperse throughout a hydrocarbon/water mixture and to reduce surfactant loss by adsorption onto rock. This enhanced dispersion may decrease the interactions between the hydrocarbon and water interface. The decreased interaction may lower the interfacial tension of the mixture and provide a fluid that is more mobile.

The invention is further illustrated by the following Examples.

### EXAMPLES

### 1. Chemicals Used in the Examples

1.1 Alcohol Alkoxy Carboxylate Surfactants A and B

Surfactants A and B were anionic surfactants of the following formula (VII):

[R—O—[PO]_{y}[EO]_{z}—CH₂C(═O)O⁻][Na⁺] Formula (VII)

The R—O moiety in the surfactants of above formula (VII) originated from a blend of primary alcohols of formula R—OH, wherein R was an aliphatic group. Said blend was a mixture of C16-17 alcohols which was a mixture of even and odd carbon number alcohols and had a weight average carbon number of 16.7. Less than 0.5% of the total alcohols were C14 and lower alcohols, 5% were C15, 31% were C16, 54% were C17, 7% were C18, 2% were C19 and less than 0.2% were C20 and higher. The aliphatic group R was randomly branched and had a branching index of 1.3-1.5. The branches consisted of approximately 87% of methyl branches and 13% of ethyl branches. In Table 1 below, “y” and “z” which represent the average number of moles of propylene oxide (PO) and ethylene oxide (EO) groups, respectively, per mole of alcohol, are shown.

TABLE 1

| | Average number of | Average number of |
|---|---|---|
| Surfactant | PO groups (y) | EO groups (z) |
| A | 3 | 5 |
| B | 0 | 4 |

1.2 Co-Solvent and Oxygen Scavenger

Further, a co-solvent was used in the Examples, namely sec-butanol (sec-butyl alcohol, hereinafter abbreviated as “SBA”). Still further, sodium bisulfite was used as an oxygen scavenger.

### 2. Evaluation Tests

Evaluated properties of surfactant compositions were: 1) microemulsion phase behaviour before acid addition; and 2) demulsification after acid addition. The tests used are described hereinbelow.

2.1 Microemulsion Phase Behaviour Before Acid Addition

In order to determine microemulsion phase behaviour, aqueous solutions comprising the surfactant and having different salinities were prepared. In tubes, the aqueous solutions were mixed with octane (model oil) in a volume ratio of 1:1 and the system was allowed to equilibrate for days or weeks at a temperature of 90° C. (resembling a reservoir temperature).

Microemulsion phase behaviour tests were carried out to screen the surfactants for their potential to mobilize residual oil by means of lowering the interfacial tension (IFT) between the oil and water. Microemulsion phase behaviour was first described by Winsor in “Solvent properties of amphiphilic compounds”, Butterworths, London, 1954. The following categories of emulsions were distinguished by Winsor: “type I” (oil-in-water emulsion), “type II” (water-in-oil emulsion) and “type III” (emulsions comprising a bicontinuous oil/water phase). A Winsor Type III emulsion is also known as an emulsion which comprises a so-called “middle phase” microemulsion. A microemulsion is characterised by having the lowest IFT between the oil and water for a given oil/water mixture.

For anionic surfactants, increasing the salinity (salt concentration) of an aqueous solution comprising the surfactant(s) causes a transition from a Winsor type I emulsion to a type III and then to a type II. The tubes containing octane (model oil) and water are mixed and allowed to equilibrate at the test temperature and the volumes of individual phases are measured in a “static phase volume method”.

Optimal salinity is defined as the salinity where equal amounts of oil and water are solubilised in the middle phase (type III) microemulsion. The oil solubilisation ratio is the ratio of oil volume (Vₒ) to neat surfactant volume (Vₛ) and the water solubilisation ratio is the ratio of water volume (V_{w}) to neat surfactant volume (Vₛ). The intersection of Vₒ/Vₛ and V_{w}/Vₛ, as salinity is varied, defines (a) the optimal salinity and (b) the solubilisation parameter (hereinafter referred to as “SP”) at the optimal salinity. It has been established by Huh that IFT is inversely proportional to the square of the solubilisation parameter (Huh, “Interfacial tensions and solubilizing ability of a microemulsion phase that coexists with oil and brine”, J. Colloid and Interface Sci., September 1979, p. 408-426). A high solubilisation parameter, and consequently a low IFT, is advantageous for mobilising residual oil via surfactant EOR. That is to say, the higher the solubilisation parameter the more “active” the surfactant.

The detailed microemulsion phase test method used in these Examples has been described previously, by Barnes et al. under Section 2.1 “Glass pressure tube test” in “Development of Surfactants for Chemical Flooding at Difficult Reservoir Conditions”, SPE 113313, 2008, p. 1-18. In summary, this test provides three important data:

(a) from the “static phase volume method”: the optimal salinity, expressed as wt. % NaCl;

(b) from the “static phase volume method”: the solubilisation parameter (SP; in ml/ml; assumption: density surfactant=1 g/ml) at the optimal salinity (this usually takes several days or weeks to allow the phases to settle at equilibrium), wherein the interfacial tension (IFT, in mN/m) is calculated from the solubilisation parameter using the “Huh” equation IFT=0.3/SP² as referred to above.

(c) from the “sway test method” described below: a measure of the “activity” of the microemulsion. In the present Examples, the “sway test method” is the main method used to judge the presence and quality of a microemulsion. The original methodology for judging the quality of the emulsion in the microemulsion phase test when gently mixing oil and water by swaying tubes is described by Nelson et al. in “Cosurfactant-Enhanced Alkali Flooding”, SPE/DOE 12672, 1984, p. 413-421 (see Table 1). This methodology has been further developed by Shell as the “sway test method” where the emulsion is visually judged in terms of four criteria:

(1) its homogeneity: the more homogeneous and “creamier”, the better as this indicates a more effective oil emulsification; good microemulsion behaviour is often described as “cappuccino like” when carried out with crude oil;

(2) its mobility: the more mobile (lower viscosity), the better;

(3) its colour: the lighter the colour, the better, indicative of microemulsions around the optimal salinity; and

(4) its glass wetting: a homogeneous film adhering to the glass surface is judged as good.

A rating method has been developed and a number ranging from 1 to 5 is given to overall microemulsion activity, from 5 for very high to 1 for very low or no activity.

2.2 Demulsification after Acid Addition

In order to determine the effect of adding an acid to an emulsion comprising octane (model oil), water and the carboxylate group containing surfactant (surfactant A or B), on (the quality of) demulsification of said same emulsion, the residual amount of any water in an octane-containing layer and the residual amount of any octane in a water-containing layer were determined, said two layers being formed upon said demulsification. Methods to determine such residual amounts of water and octane are well-known in the art. For example, said residual amount of water may be determined by the “Karl Fischer” method. Further, said residual amount of octane may be determined by a method involving GC-GC (GC=gas chromatography). Samples were taken at three different levels in each layer using a glass pipette with an elongated narrow tip which was carefully immersed in the layer in question to avoid mixing of the layers.

### 3. Examples

In Table 2 below, the conditions of the above-described evaluation tests are summarized for Examples 1-2 (E1 and E2).

TABLE 2

| | | | | | Sodium | |
|---|---|---|---|---|---|---|
| | Model | Surfac- | Total AM | SBA | bisulfite | Test T |
| Ex. ⁽¹⁾ | oil | tant | (wt. %) ⁽²⁾ | (wt. %) | (ppmw) ⁽⁴⁾ | (° C.) ⁽³⁾ |
| E1 | octane | A | 2 | 4 | 60 | 90 |
| E2 | octane | B | 2 | 4 | 60 | 90 |

(1) “E1” means “Example 1”. In this table, weight percentages are based on total weight of the aqueous solution (only).
(2) Total AM refers to total active matter, that is to say the total weight percentage of the surfactant.
(3) “Test T” refers to both the phase behaviour test temperature and the demulsification test temperature.
(4) Sodium bisulfite and a nitrogen blanket in the tubes were used to prevent oxidation of alkoxy groups of the surfactant that would otherwise occur. This reproduces the anaerobic conditions of a crude oil containing reservoir.

After standing for several weeks in an oven at 90° C. and before an acid was added, the pH of the overall emulsion comprising octane (model oil), water and the carboxylate group containing surfactant (surfactant A or B), was stabilized at a value of 6.0. To this emulsion having a pH of 6.0, such amount of a dilute aqueous sulfuric acid solution was added so as to reduce the pH to 4.0. For the experiments, 10-20 drops of 0.5 M (molar) sulfuric acid (each drop being about 0.02 ml) was added. The amount added depended on the phase behaviour tube. This corresponded to a dosage of 1-2% v/v for each oil+water tube. After acid addition the tubes were thoroughly mixed and put back into the oven.

In Table 3 below, the results of the above-described evaluation tests are summarized for Examples 1-2 (E1 and E2). In all of the microemulsion phase behaviour tests for E1 and E2, the salinity (or TDS concentration, wherein “TDS” refers to “total dissolved solids” comprising dissolved salts) of the aqueous solution was varied by varying the NaCl concentration. As described above in section 2.1, in all of said cases, the volume ratio of octane (model oil) to water (that is to say, the aqueous, surfactant containing solution) was 1:1 (50:50).

TABLE 3

| | |
|---|---|
| Microemulsion | Demulsification |
| phase behaviour | after acid addition |

| | before acid addition | | | | Water | Octane |
|---|---|---|---|---|---|---|
| | Opt. sal. | III width | Highest act. | wt. % | in octane | in water |
| | (wt. % | (wt. % | (wt. % | NaCl | layer | layer |
| Ex. | NaCl) | NaCl) | NaCl) | in tube | (wt. %) | (wt. %) |
| E1 | 4.75 | 4.5-6.5 | 5.5-6.0 | 5.0 | 2.67 | n.m. |
| | | | | 5.5 | 2.42 | n.m. |
| | | | | 6.0 | 2.95 | n.m. |
| | | | | 6.5 | 2.57 | n.m. |
| E2 | 7.75 | 6.0-9.0 | 7.50 | 7.0 | 0.16 | 0.013 |
| | | | | 7.5 | 0.15 | 0.024 |
| | | | | 8.0 | 0.16 | n.m. |
| | | | | octane | 0.004 | n.a. |
| | | | | reference | | |

n.m. = not measured;
n.a. = not applicable;
“E1” means “Example 1”;
“Opt. sal.” means “Optimal salinity”;
“act.” means “activity”;
“III width” refers to the width of the salinity (TDS) range in which emulsion (Winsor) type “III” was observed, as measured by the “sway test” method (the lowest and highest TDS concentrations at which this was observed are indicated).

Table 3 shows that before acid addition, the carboxylate group containing surfactants A and B have a good microemulsion phase behaviour. This for example appears from the relatively wide salinity (TDS) range in which emulsion (Winsor) type “III” phase behaviour was observed. This in turn advantageously implies that the salinity range within which the interfacial tension (IFT) between water and the hydrocarbons in a hydrocarbon containing formation can be reduced to a certain level is relatively wide. Showing such good microemulsion phase behaviour in a wide range of salinities is an important selection criterion for surfactants.

By adding the acid to the overall emulsion comprising octane (model oil), water and the carboxylate group containing surfactant (surfactant A or B), demulsification of that emulsion was effected, resulting in one separate octane-containing layer and one separate water-containing layer. These 2 layers can be easily separated, either by using a separatory funnel or a thin pipetted syringe in the laboratory, or by using a bulk produced fluid separation tank in the field as described above in the description preceding the Examples.

In order to demonstrate that demulsification was indeed effected, the microemulsion phase behaviour was assessed, also after acid addition. It appeared that after an hour in the oven, the emulsion to which acid had been added, was broken as evidenced by the disappearance of the third middle phase (indicative of a Winsor Type III emulsion) in the tubes having a salinity around the optimal salinity. The tubes were also evaluated via the above-described “sway test method” to assess the quality of the microemulsion and this showed that the tubes that had originally such third middle phase and excellent microemulsion behaviour, exhibited a poor microemulsion behaviour at pH=4. These observations were consistent with the carboxylate group containing surfactant having been de-activated at all salinities by the addition of acid, presumably via protonation of the carboxylate group.

Not only was demulsification effected upon acid addition, as described above, but in addition the quality of that demulsification was relatively high implying that the residual amounts of water and octane in the octane layer and water layer, respectively, were relatively low. These residual amounts are shown in Table 3 above. The separated oil phase samples were visually transparent/clear in all cases indicating that they had relatively low water contents.

It is preferred that the remaining amount of any water in the oil layer, is relatively low, at least below 10 wt. % and preferably below 0.5%. In the produced fluid treatment plant the typical target output oil quality from the bulk separation tank is 10 wt. % water in oil and the typical target output oil quality following a second treatment stage, oil dehydration, is <0.5 wt. % water in oil. Further, it is preferred that the remaining amount of any oil in the water layer after the bulk separation stage is relatively low, for example <0.2 wt. % and preferably <0.01 wt. % oil in water. The water is further processed in the produced fluid treatment plant to remove oil further and give a target oil content in water of <30 ppmw.

Thus, based on the above-measured water in oil and oil in water levels in the separated layers (see Table 3 above), in the present invention, using a carboxylate group containing compound of the formula (I) as the surfactant and adding an acid to an emulsion comprising hydrocarbons (octane or oil), water and the carboxylate group containing surfactant appear to be quite effective at breaking such emulsion and producing relatively clean, separated oil and water layers.

1. A method of treating a hydrocarbon containing formation, comprising the following steps:
a) providing a composition comprising a surfactant to at least a portion of the hydrocarbon containing formation, wherein the surfactant is a compound of the formula (I)
R—O—[R′—O]ₓ—X Formula (I)
wherein R is a hydrocarbyl group, R′—O is an alkylene oxide group, x is the number of alkylene oxide groups R′—O, and X is a group comprising a carboxylate moiety;
b) allowing the surfactant from the composition to interact with the hydrocarbons in the hydrocarbon containing formation;
c) recovering from the hydrocarbon containing formation an emulsion comprising hydrocarbons, water and the surfactant; and
d) adding an acid to the emulsion thus recovered.

2. Method according to claim 1, wherein the amount and pKₐ of the acid that is added are such that the pH of the emulsion is decreased to a value below 7.

3. Method according to claim 1, wherein the acid is organic or inorganic, preferably sulfuric acid, hydrochloric acid or acetic acid.
